(19) United States
(12) Patent Application Publication
(10) Pub. No.: US 2024/0316670 A1
(43) Pub. Date: Sep. 26, 2024

(54) COMPUTER MODELING FOR DETECTION OF DISCONTINUITIES IN WELDED STRUCTURES

(71) Applicant: NEWFREY LLC, New Britain, CT (US)

(72) Inventors: Amir R. Kashanipour, New Britain, CT (US); Maxim Dalton, New Britain, CT (US); Shengnan Wang, New Britain, CT (US)

(73) Assignee: NEWFREY LLC, New Britain, CT (US)

(21) Appl. No.: 18/546,038

(22) PCT Filed: Feb. 9, 2022
(86) PCT No.: PCT/US2022/015808

§ 371 Date: Aug. 10, 2023

Related U.S. Application Data
(60) Provisional application No. 63/148,010, filed on Feb. 10, 2021.

(51) Int. Cl. B23K 9/095; B23K 31/12

(52) U.S. Cl. CPC B23K 9/0953; B23K 9/0956; B23K 31/125

(57) ABSTRACT

Disclosed herein are systems and methods for identifying welding anomalies and discontinuities using AI models. Instead of conventional welding accuracy methods (e.g. destructive and/or image generation methods) a processor may communicate with one or more sensors associated with a welding machine to retrieve welding data and attributes. The processor may then execute an AI model that is trained based on previously performed weldments, their corresponding welding attributes, and their corresponding discontinuities and/or anomalies. The processor may execute the AI model using data retrieved from the sensors and may calculate a likelihood of a discontinuity and discontinuity attributes, such as, location, depth, and the like. The processor may then display a visual representation of the discontinuities calculated using the AI model.

### CROSS-REFERENCE TO RELATED APPLICATIONS

This application claims priority to U.S. Provisional Patent Application No. 63/148,010, filed Feb. 10, 2021, which is incorporated herein by reference in its entirety for all purposes.

### TECHNICAL FIELD

This application relates generally to generating, training, and operating computer models to detect, analyze, and visualize discontinuities in welded structures.

### BACKGROUND

Identifying discontinuities and defects in a weldment is of immense importance, particularly in oil and gas pipelines where a discontinuity in welding of pipelines can lead to a leak at a high economic or environmental cost. Various types of discontinuities may include, but are not limited to, cracks, presence of pores and bubbles, incomplete or insufficient penetration of weldment, linear misalignment of metallic bodies, lack of thorough fusion between the metallic bodies, undercut or over enforcement of weld material in upper or lower weld zones, or blowout of the top surface formation. Early identification of presence, type, size, and location of discontinuities in weldments can help welding and inspection technicians make the necessary repairs in a cost-effective manner. As used herein, size may refer to length, width, and/or volume of the discontinuity corresponding to its shape (e.g., head angle of the discontinuity).

Conventional methods and systems have proven to be ineffective and/or undesirable. Some known techniques for detection of discontinuities include use of ultrasonic or optical scanners. Some conventional methods use X-ray machines that scan a peripheral area of a pipeline around the weldment and produce X-ray images corresponding to the weldment. A technician visually reviews the X-ray images to identify discontinuities in the weldment. But visual inspection of the X-ray images is not consistently reliable due to human error. Moreover, this method relies on the subjective skills of each technician, which produces inconsistent results.

In another example, some conventional methods rely on artificial intelligence (AI) platforms that use ultrasound signals to identify the location of discontinuities and anomalies. In these methods/systems, a neural network monitors ultrasound waveforms for presence patterns that can help identify the location, depth, and to some extent the type of discontinuities in the weldment. Due to limitations of sound waveforms, however, these methods are significantly limited in the types of discontinuities that can be identified.

### SUMMARY

For the aforementioned reasons, there is a desire for a non-invasive and non-destructive solution to identify anomalies and discontinuities in weldments. There is a desire for a computer model to generate data indicating anomalies and discontinuities, such that the results simulate conventional anomaly-detection methods. Further, what is needed is a system to automate the discontinuity detection process and to enable accurate and reliable detection and classification of a wide variety of types of discontinuities and discontinuities in a weldment. There is a desire for a computer system to produce results that are no longer dependent on technicians' subjective skills and interpretation. The methods and systems described herein provide a formalized approach to identifying anomalies in a single automated framework with little to no human intervention. The embodiments herein may provide a solution by using AI modeling techniques to generate images that resemble conventional X-ray images representing weldments.

In an embodiment, a method comprises receiving, by a processor, a plurality of attributes corresponding to a weldment; executing, by the processor, a first artificial intelligence model to identify one or more attributes associated with at least one discontinuity of the weldment, wherein the first artificial intelligence model was trained based on one or more attributes corresponding to previous weldments having at least one discontinuity, and wherein the one or more attributes associated with the at least one discontinuity of the weldment correspond to at least one of a type or a location of the discontinuity; and presenting, by the processor, the one or more attributes associated with at least one discontinuity for display.

The processor may receive the plurality of attributes from a welding machine.

The method may also execute a second artificial intelligence model that receives an input of the one or more attributes associated with the at least one discontinuity generated by the first artificial intelligence model and generates an image that simulates the at least one discontinuity, wherein the second artificial intelligence model was trained based on one or more attributes associated with the at least one discontinuity corresponding to previous weldments and one or more visual attributes associated with the at least one discontinuity of the previous weldments; and presenting, by the processor, the image generated by the second artificial intelligence model for display.

The image may simulate an X-ray image of the weldment or a pseudo-ultrasound image of the weldment.

The plurality of attributes may comprise at least one of event description, time associated with welding of the weldment, changes per tilt, tilt attributes, travel speed, distance, volts, direction, amps, wire speed, oscillation width, target, horizontal right bias, oscillation rates, wire consumed, or energy.

The at least one attribute within the one or more attributes associated with the at least one discontinuity may correspond to a discontinuity size.

The first artificial intelligence model may calculate a likelihood of discontinuity being present within the weldment.

The first artificial intelligence model may further calculate a depth associated with each discontinuity.

Responsive to an identification by the first artificial intelligence model, the method may further comprise transmitting, by the processor, an instruction to a welding machine to modify a welding process.

The instruction may comprise at least one of re-calibration of the welding machine, auto-correction of the welding machine, or indication of a problematic area of the weldment.

In another embodiment, a system comprises a processor associated with a non-transitory computer-readable medium containing instructions that when executed by the processor causes the processor to perform operations comprising: receive a plurality of attributes corresponding to a weldment; execute a first artificial intelligence model to identify one or more attributes associated with at least one discontinuity of the weldment, wherein the first artificial intelligence model was trained based on one or more attributes corresponding to previous weldments having at least one discontinuity, and wherein the one or more attributes associated with the at least one discontinuity of the weldment correspond to at least one of a type or a location of the discontinuity; and present the one or more attributes associated with at least one discontinuity for display.

The processor may receive the plurality of attributes from a welding machine.

The instruction may further cause the processor to execute a second artificial intelligence model that receives an input of the one or more attributes associated with the at least one discontinuity generated by the first artificial intelligence model and generates an image that simulates the at least one discontinuity, wherein the second artificial intelligence model was trained based on one or more attributes associated with the at least one discontinuity corresponding to previous weldments and one or more visual attributes associated with the at least one discontinuity of the previous weldments; and present the image generated by the second artificial intelligence model for display.

The image may simulate an X-ray image of the weldment or a pseudo-ultrasound image of the weldment.

The plurality of attributes may comprise at least one of event description, time associated with welding of the weldment, changes per tilt, tilt attributes, travel speed, distance, volts, direction, amps, wire speed, oscillation width, target, horizontal right bias, oscillation rates, wire consumed, or energy.

The at least one attribute within the one or more attributes associated with the at least one discontinuity may correspond to a discontinuity size.

The first artificial intelligence model may calculate a likelihood of discontinuity being present within the weldment.

The first artificial intelligence model may further calculate a depth associated with each discontinuity.

The instructions may further cause the processor to transmit an instruction to a welding machine to modify a welding process responsive to an identification by the first artificial intelligence model.

The instruction may comprise at least one of re-calibration of the welding machine, auto-correction of the welding machine, or indication a problematic area of the weldment.

### BRIEF DESCRIPTION OF THE DRAWINGS

Non-limiting embodiments of the present disclosure are described by way of example with reference to the accompanying figures, which are schematic and are not intended to be drawn to scale. Unless indicated as representing the background art, the figures represent aspects of the disclosure.

FIG. 1A illustrates components of an anomaly-detection system, according to an embodiment.

FIG. 1B illustrates an image of a weldment, according to an embodiment.

FIG. 2 illustrates a flow diagram of a process executed in an anomaly-detection system, according to an embodiment.

FIG. 3A illustrates a flow diagram of a process executed in an anomaly-detection system, according to an embodiment.

FIG. 3B illustrates different clustering methods to train the first AI model, according to an embodiment.

FIG. 4 illustrates a flow diagram of a process executed in an anomaly-detection system, according to an embodiment.

FIG. 5 illustrates welding data received from one or more sensors, according to an embodiment.

FIGS. 6-9 illustrate visualizations of welding discontinuities, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting of the subject matter presented.

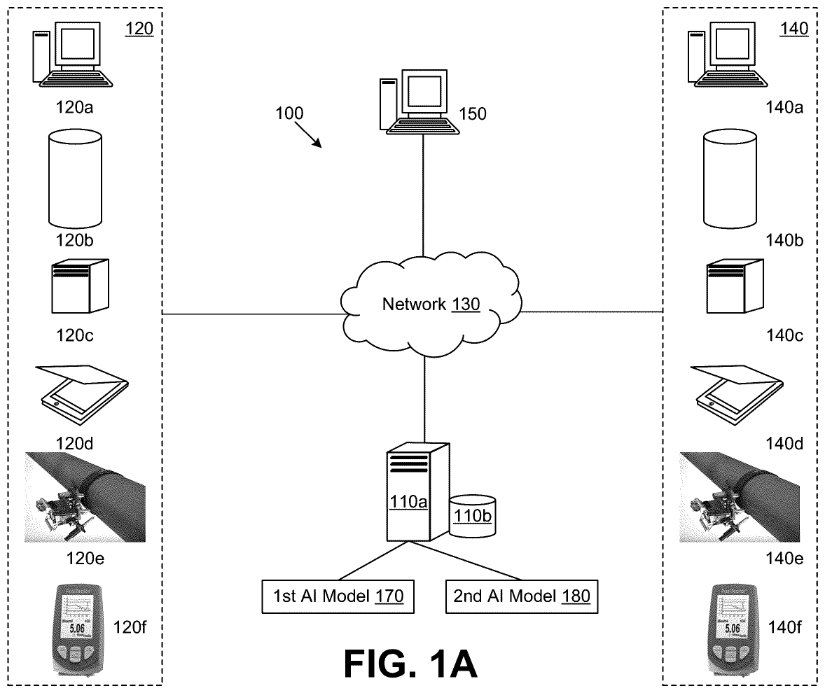

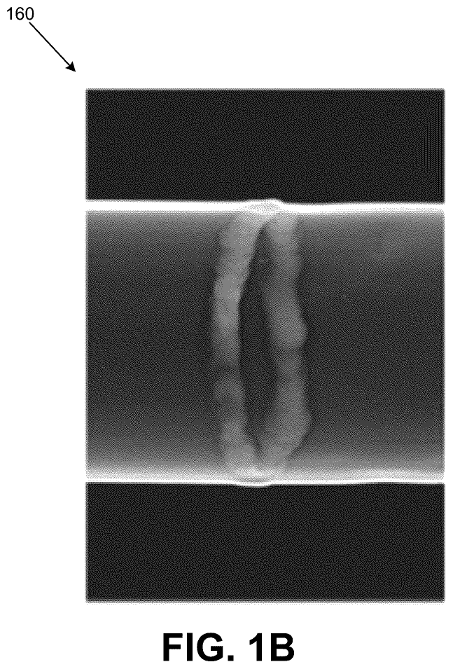

As will be described below, a central server (referred to herein as the analytics server) can retrieve and analyze data using various methods described herein to identify weldment anomalies. FIG. 1A is a non-limiting example of components of an anomaly-detection system 100 in which an analytics server 110a operates. The analytics server 110a may utilize features described in FIG. 1A to retrieve data and generate/display results. The analytics server 110a is communicatively coupled to a system database 110b, electronic data sources 120a-d (collectively electronic data sources 120), end-user devices 140a-f (collectively end-user device 140), and an administrator computing device 150. The system 100 is not confined to the components described herein and may include additional or other components, not shown for brevity, which are to be considered within the scope of the embodiments described herein.

The above-mentioned components may be connected to each other through a network 130. The examples of the network 130 may include but are not limited to, private or public LAN, WLAN, MAN, WAN, and the Internet. The network 130 may include both wired and wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, e.g., a GSM (Global System for Mobile Communications), CDMA (Code Division Multiple Access), EDGE (Enhanced Data for Global Evolution) network.

The analytics server 110a may utilize one or more application programming interfaces (APIs) to communicate with one or more of the electronic devices described herein. For instance, the analytics server may utilize APIs to automatically receive data from the electronic data source 120. The analytics server 110a can receive data as it is generated, monitored, and/or processed by the electronic data source 120. For instance, the analytics server 110a may utilize an API to receive welding data from the welding machine 120e without any human intervention. This automatic communication allows for faster retrieval and processing of data.

The analytics server 110a may generate and generate and/or host a graphical user interface (GUI) configured to use various computer models (including artificial intelligence (AI) models) to identify and display weldment discontinuities and anomalies. The GUI can be displayed on the electronic data source 120, the administrator computing device 150, and/or end-user devices 140. An example of the GUI generated and/or hosted by the analytics server 110a may be a web-based application or a website configured to be displayed on different electronic devices, such as mobile devices, tablets, personal computers, and the like. Even though certain embodiments discuss the analytics server 110a displaying the results, it is expressly understood that the analytics server 110a may either directly generate and display the GUIs described herein or may present the data to be presented on a GUI displayed on the end-user devices 140.

In a non-limiting example, a technician operating the technician device 120d may instruct the analytics server 110a to display discontinuities/anomaly data. The analytics server 110a may then display the results in accordance with the end-user's (e.g., technician's) request. For instance, the analytics server 110a may display an image that resembles an X-ray generated by the welding machine 120e. In some configurations, the analytic server 110a may directly transmit the results to a computer of the welding machine 120e.

The analytics server 110a may host a website accessible to end-users operating any of the electronic devices described herein (e.g., end-users), where the content presented via the various webpages may be controlled based upon each particular user's role or viewing permissions. The analytics server 110a may be any computing device comprising a processor and non-transitory machine-readable storage capable of executing the various tasks and processes described herein. Non-limiting examples of such computing devices may include servers, computers, workstation computers, personal computers, and the like. While this example of the system 100 includes a single analytics server 110a, in some configurations, the analytics server 110a may include any number of computing devices operating in a distributed computing environment.

The analytics server 110a may execute one or more software applications configured to display the GUI (e.g., host a website), which may generate and serve various webpages to each electronic data source 120 and/or end-user devices 140. Different end-users may use the website to view and/or interact with the predicted results. In some configurations, the analytics server 110a may display the results on any of the computing devices depicted in FIG. 1A.

The analytics server 110a may be configured to require user authentication based upon a set of user authorization credentials (e.g., username, password, biometrics, cryptographic certificate, and the like). In such implementations, the analytics server 110a may access the system database 110b configured to store user credentials, which the analytics server 110a may be configured to reference in order to determine whether a set of entered credentials (purportedly authenticating the user) match an appropriate set of credentials that identify and authenticate the user.

The analytics server 110a may also store data associated with each user operating one or more electronic data sources 120 and/or end-user devices 140. The analytics server 110a may use the data to weigh interaction while training various AI models accordingly. For instance, the analytics server 110a may monitor a technician's interactions with the results and train the machine-learning or other computer models described herein based on the technician's interactions.

In some configurations, the analytics server 110a may generate and host the GUI based on a particular user's role within the system 100. In such implementations, the user's role may be defined by data fields and input fields in user records stored in the system database 110b. The analytics server 110a may authenticate the end-user and may identify the end-user's role by executing an access directory protocol (e.g., LDAP). The analytics server 110a may generate webpage content that is customized according to the user's role defined by the user record in the system database 110b.

The analytics server 110a receives welding data and other pertinent data from one or more of the electronic data sources 120, analyzes the data and displays the results. For instance, in a non-limiting example, the analytics server 110a may query and retrieve welding data from the welding machine 120e and combine the welding data with other data received/retrieved from a technician operating the technician device 120d. The analytics server 110a then uses various models (e.g., stored within the system database 110b) to analyze the retrieved data. The analytics serve 110a then displays the results via the GUIs described herein on the administrator computing device, the end-user devices 140, and/or the electronic technician device 120d.

The welding machine 120e may be configured for automatic welding of an area, for instance, a pipeline. The welding machine 120e may include various sensors that can monitor welding attributes and communicate said attributes (e.g., weld log) to the analytics server. For instance, the welding machine 120e may include a processor and a communication module allowing the welding machine 120e to transmit (e.g., using wireless or wired technology) welding data to the analytics server 110a. As will be described below, the analytics server 110a may use the data provided by the welding machine 120e to identify and/or visualize welding discontinuities and anomalies.

The welding machine 120e may also include one or more imaging apparatus to generate an image of the weldment, such as depicted in FIG. 1B. The image is depicted in FIG. 1B is an X-ray image produced by the imaging apparatus communicatively coupled to the welding machine 120e. The imaging apparatus (not shown in the figures for brevity) may scan a weldment connecting two pieces (e.g., two pipelines), according to an embodiment. The imaging apparatus may include a guide rail disposed around a completed weldment of a pipeline and a transmitter that transmits X-ray beams and is movably mounted on the guide rail. The imaging apparatus may also include a receiver disposed movably on the guide rail across the transmitter that receives the X-ray beams through the weldment, creating images of the weldment that correspond to its current location. In some configurations, the analytics server may utilize other types of optical, laser, or radiation sensors capable of providing images representing the interior structure of the weldment. As will be described below, the analytics server may process the images obtained by the imaging apparatus in communication with the welding machine 120e.

Even though the example refers to a singular image, it is expressly understood that the imaging apparatus of the welding machine 120e may transmit multiple images. The analytics server 110a may process these segmented images to analyze the weldment. For instance, the imaging apparatus may provide a series of discrete image segments, each corresponding to an angular segment of the weldment. In another example, the analytics server 110a may compile the images to provide a linear image including the image segments placed together in an array. The analytics server 110a may transmit the discrete image segments and/or the linear image array to the discontinuity detection unit for manual and/or autonomous inspection and detection of discontinuities in the weldment. Furthermore, in some configurations, the analytics server 110a may analyze the images captured to identify discontinuities.

The transmitter and receiver of the imaging apparatus in communication with the welding machine 120e may move synchronously around the full periphery of the weldment, creating a series of images that capture the full 360-degree view of the weldment. Even though aspects of the imaging apparatus are described within the context of X-ray imaging, the methods, and systems described herein apply to all imaging to monitor weldments (e.g., ultrasound images).

The analytics server 110a may receive data from the electronic data source 120, analyze the data using various methods described herein, and display the results (or present the results to be displayed) on one or more GUIs displayed on the end-user devices 140. Even though certain electronic data sources 120a-f and end-user devices 140a-f are shown as separate devices, it is understood that a single device can both provide data to the analytics server and display the results. In an example, the analytics server 110a may receive data from the welding machine 120e and may display the results onto (or otherwise transmit the results to) the same welding machine 120e (depicted as the welding machine 140e). In another example, the technician device 140d and 120d may refer to the same device. Therefore, a single device can act as both a data source and an end-user device.

The methods described herein can also be implemented on any of the devices depicted in FIG. 1A. For instance, the analytics server 110a may be associated with (e.g., physically connected) the welding machine 120e, 140e or the welding inspection machine 120f, 140f. The analytics server 110a can directly receive welding data associated with a weldment and display various notifications described herein. Therefore, the depicted arrangement of computing features is a non-limiting example of a system architecture that can utilize the methods described herein to identify and/or visualize welding anomalies.

FIG. 1B depicts a perspective view of the image 160 generated by the imaging device disposed for scanning a weldment connecting two pipelines, according to an embodiment. As will be described herein, trained technicians may analyze welding images, such as the image 160. Moreover, as will be described herein, the analytics server 110a may use welding images, such as the image 160, to train one or more AI models. Moreover, the analytics server 110a may also use various techniques (e.g., execution of one or more AI models) to produce images (e.g., pseudo-X-ray or pseudo ultrasound images that simulate X-ray or ultrasound images) that are similar to the image 160. Trained technicians may utilize these pseudo-images to identify weldment discontinuities and anomalies.

Referring back to FIG. 1A, the end-user devices 140 may be any computing device comprising a processor and a non-transitory machine-readable storage medium capable of performing the various tasks and processes described herein. Non-limiting examples of an end-user device may include workstation computers, laptop computers, tablet computers, and server computers. In operation, various end-users may use end-user devices 140 to access the GUI operationally managed by the analytics server 110a. Specifically, the end-user devices 140 may include job site computer 140a, job site database 140b, job site server 140c, technician device 140d, and/or the welding machine 140e.

The electronic data sources 120 may represent various electronic data sources that contain, retrieve, and/or input data associated with welding. For instance, the analytics server 110a may use the job site computer 120a, database 120b, server 120c, and technician device 120d (associated with the job site) to retrieve/pertinent data. In some configurations, the analytics server 110a may retrieve data and display the results on the same device.

The administrator computing device 150 may represent a computing device operated by a system administrator. The administrator computing device 150 may be configured to display retrieved data, in the form of results generated by the analytics server 110a, where the system administrator can monitor various models utilized by the analytics server 110a, review feedback, and modify various thresholds/rules described herein.

Even though certain embodiments describe how the analytics server 110a can identify weldment in pipelines, it is expressly understood that the methods and systems described herein apply to all weldments.

In operation, the welding machine 120e may automatically weld predetermined portions of a pipeline. The welding machine 120e may also include an imaging apparatus that can automatically and periodically generate weldment images. The analytics server 110a may be instructed by an end-user operating the technician device 140d to analyze welding performed by the welding machine 120e. Using the methods and systems described herein, the analytics server 110a may communicate with one or more sensors of the welding machine 120e and retrieve various welding attributes associated with the weldment to be analyzed. Additionally or alternatively, the analytics server 110a may also retrieve one or more images generated by the welding machine 120e.

The analytics server 110a stores a plurality of AI models. Although the example system has the AI models stored on the analytics server 110a, the AI models may be stored on another device or server. The analytics server 110a may execute a first AI model 170 to generate a set of scores indicating a likelihood of discontinuity for different areas of the weldment. Specifically, the analytics server 110a may receive welding attributes from the welding machine 120e. The welding machine 120e may include various sensors that monitor the welding performed by the welding machine 120e. The sensors may transmit various attributes (e.g., welding log) to the analytics server 110a, such as a lead and/or tail amp (when applicable), tilt, travel speed, and the like.

The first AI model 170 may have been previously trained by the analytics server 110a using previously performed weldments, their corresponding attributes (welding logs), and corresponding discontinuities. The first AI model 170 may ingest the data received from the welding machine 120e and may calculate scores for different zones of the weldment each indicating a likelihood of discontinuity.

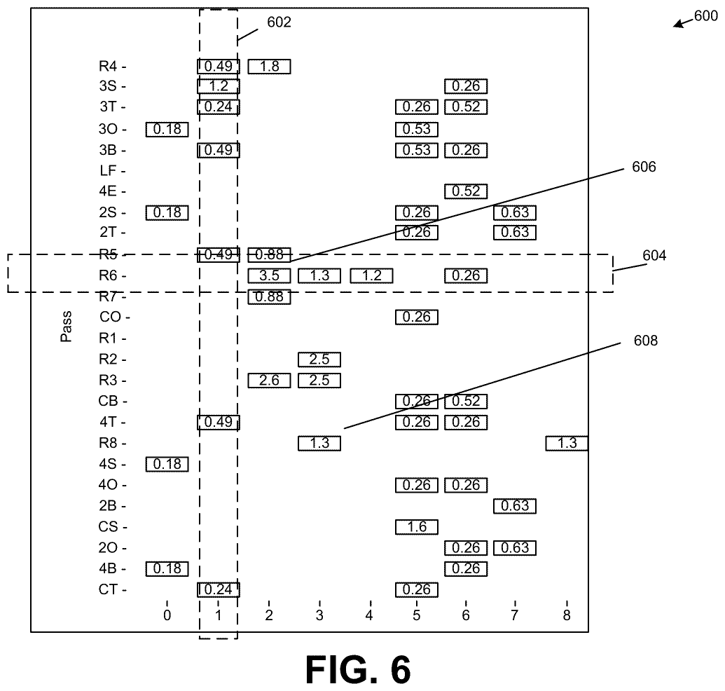

Upon identifying the likelihood of discontinuities for different areas of the weldment, the analytics server 110a may display results on the GUIs accessible by the end-user devices 140. The analytics server 110a may generate various visual representations of the results, as depicted in FIG. 6-10. In some embodiments, the analytics server 110a may execute a second AI model 180 to generate a pseudo-image of the weldment (e.g., pseudo-X-ray) and display the pseudo image, such that the pseudo image can be analyzed by the end-users interacting with the GUI.

The second AI model 180 may receive the scores generated by the first AI model 170. The second AI model 180 may have been previously trained using discontinuities, discontinuity attributes, and how the discontinuity attributes manifest themselves on a weldment image (e.g., an X-ray generated from the weldment). The second AI model 180 may then ingest the scores generated by the first AI model 170 and may generate a pseudo-image of the weldment (e.g., pseudo-X-ray).

Additionally or alternatively, the analytics server 110a may directly communicate with one or more devices, such as the welding machine 120e. The analytics server 110a may control and/or modify the behavior of the welding machine 120e in accordance with the results outputted by the first AI model 170. For instance, the analytics server 110a may instruct the welding machine 120e (or any other components) to cease welding operations when weldment errors/discontinuities have been identified. In another example, the analytics server 110a may instruct the welding machine 120e to perform various tasks that mitigate the identified welding discontinuities and/or produce additional images. In some configurations, the methods and systems described herein can be executed, such that real-time monitoring of weldments is available.

The instructions may also allow the welding machine 120e to re-calibrate itself accordingly. For instance, the instructions may indicate where the discontinuities are located (along with attributes of the discontinuity, such as depth or type of the discontinuity). Using various correction and calibration protocols, the welding machine 120e may correct its welding parameters, such that similar discontinuities no longer occur. For instance, when an anomaly is detected, the welding machine 120e may analyze various parameters of the performed welding and may revise those parameters for future weldments, such that anomalies are no longer occurring. This concept is also referred to as adaptive welding.

The analytics server 110a can rely on data received using non-destructive methods to reverse engineer welding discontinuities and anomalies. The analytics server 110a may use welding data to generate a pseudo-image associated with the predicted discontinuities and anomalies (using the first AI model 170 and the second AI model 180). In some configurations, the methods and systems described herein can be utilized in conjunction with other welding and error-detection methods to provide an automated error-proof welding process.

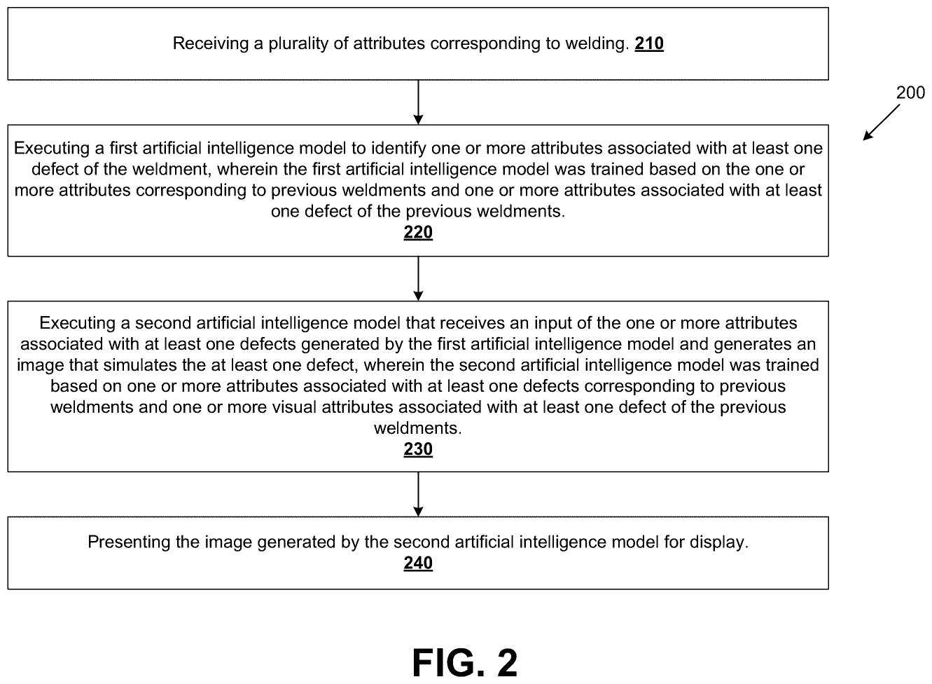

FIG. 2 illustrates a flow diagram of a process executed in an anomaly-detection system, according to an embodiment. The method 200 includes steps 210-240. However, other embodiments may include additional or alternative execution steps or may omit one or more steps altogether. The method 200 is described as being executed by a server, similar to the analytics server described in FIG. 1A. However, one or more steps of method 200 may also be executed by any number of computing devices operating in the distributed computing system described in FIG. 1. For instance, one or more computing devices (e.g., end-user devices) may locally perform part or all the steps described in FIG. 2.

At step 210, the analytics server may receive a plurality of attributes corresponding to welding. A non-limiting example of data received by the analytics server may include weld log or welding log data (sometimes referred to herein as W-log). In order to weld two pieces together, a welding machine (e.g., utilizing an automated process) or a technician may fill a bevel between the two pieces. The welding process may consist of iteratively welding the bevel in different layers. Each iteration may also be referred to herein as a “pass” or a “layer.” This welding process may also be referred to as the weld pass sequence. Accordingly, every layer may have its unique chemistry and material treatment. The welding machine may include various sensors configured to measure various attributes of each zone/pass. For instance, one or more sensors may direct a known amount of electrical current through one or more layers to identify one or more attributes of the weldment.

The welding machine may transmit a file containing the weld log to the analytics server where the analytics server parses the data within the weld log to identify each attribute collected by the sensors. Non-limiting examples of the attributes received by the analytics server may include event descriptions, time associated with each event (elapsed in milliseconds), tilt (absolute reading measure than degrees), zone (input index for SB automatically changes per tilt), travel speed (inches per minute), distance (measured in inches and varied based on starting points), lead and/or tail (when applicable) volts (torch or PS), direction, lead and/or tail (when applicable) amps, lead and/or tail (when applicable) wire speed (inches per minute), lead and/or tail (when applicable) oscillation width, lead and/or tail (when applicable) target (measured in volts), lead and/or tail (when applicable) horizontal right bias, lead and/or tail (when applicable) oscillation rates (frequency per minute), lead and/or tail (when applicable) wire consumed (encoder/motor measured in inches), and lead and/or tail (when applicable) energy measured in kilojoules per inch. The analytics server may parse the data received from the welding machine and may generate/store the parsed data as a CSV file for further analytics.

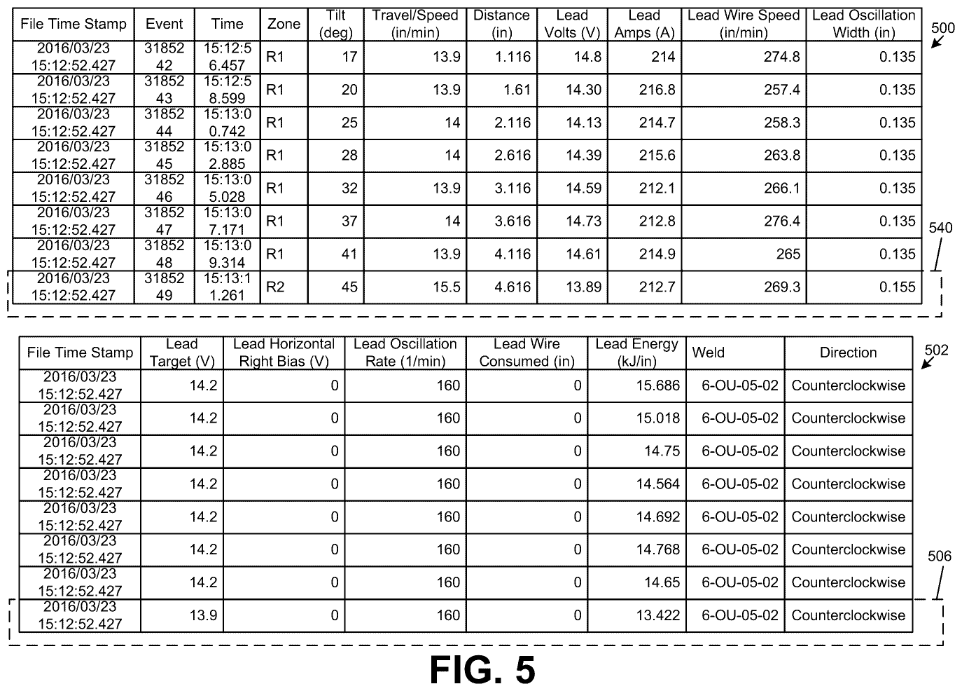

FIG. 5 depicts an example of weld logs 500, 502, which include data retrieved from one or more sensors associated with a welding machine. The weld logs 500 and 502 include a timestamp and the corresponding welding attributes. For instance, rows 504 and 506 indicate welding attributes of the welding performed by the welding machine on Mar. 23, 2016, at 15:12:52. As identified in row 504, the welding machine performed events 3185249 on zone R2. The rows 504-6 also identify tilt, travel speed, distance, lead and/or tail (when applicable) voltage, lead and/or tail (when applicable) amps, lead and/or tail (when applicable) wire speed, lead and/or tail (when applicable) oscillation width, lead and/or tail (when applicable) target, lead and/or tail (when applicable) horizontal right bias, lead and/or tail (when applicable) oscillation rate, lead and/or tail (when applicable) wire consumed, lead and/or tail (when applicable) energy, weld, and direction of actions performed at the identified timestamp.

The analytics server may parse the weld log received from the welding machine (or other data sources) and may extract the above-described attributes. As will be described below, the analytics server may then apply the welding attributes/data to one or more AI models to predict a likelihood of discontinuities of the weldment.

Additionally or alternatively, the analytics server may retrieve data associated with the material used for the weldment. Furthermore, when the welding is performed manually, the analytics server may retrieve hand movement data associated with the welder (e.g., how the welding apparatus was handled can be monitored using various sensors).

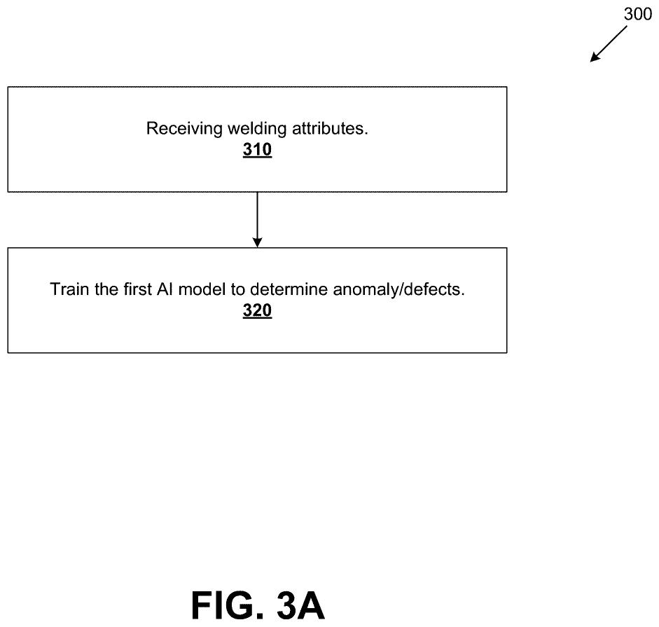

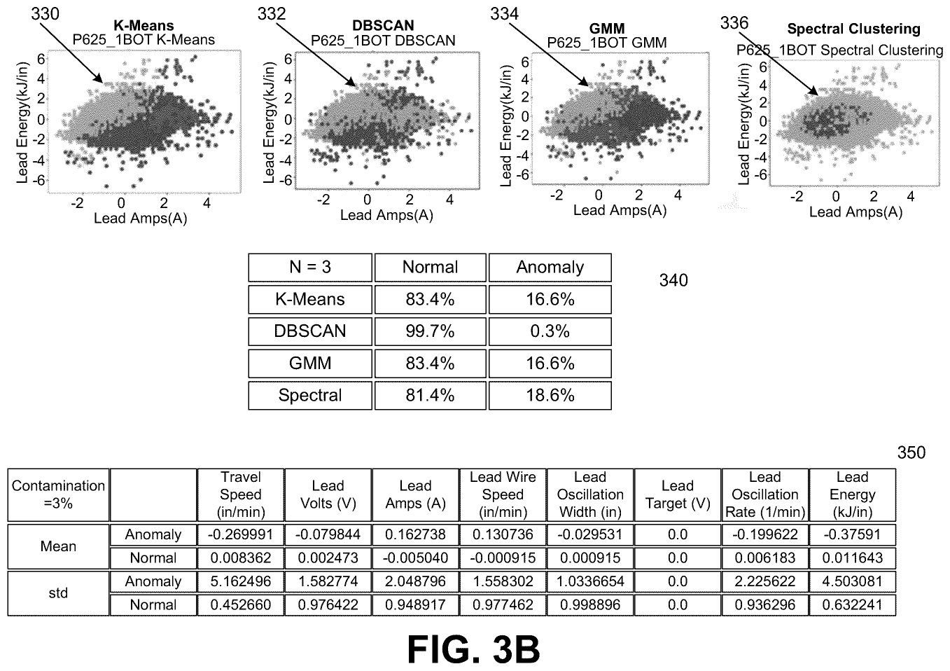

Referring back to FIG. 2, at step 220, the analytics server may execute a first AI model to identify one or more attributes associated with at least one discontinuity associated with the welding, the first AI model being trained based on previously performed weldments and their corresponding discontinuity attributes. The analytics server may execute the first AI model using one or more of the attributes received at step 210. The first AI model may be previously trained, such that the first AI model ingests welding attributes received and generates a likelihood of discontinuity and anomalies associated with the weldment. Method 300 of FIG. 3A is a non-limiting example of how the analytics server trains and prepares the first AI model using welding data. The analytics server may train the first AI model, such that at the time of executing the step 220, the first AI model is trained. As will be described below, the analytics server may continuously retrain, recalibrate, and revise the first AI model in order to improve its accuracy.

FIG. 3A illustrates a non-limiting example of training the first AI model, in accordance with an embodiment. At step 310, the analytics server may generate a training dataset used to train the first AI model. The training dataset may include previous weldment data. For instance, the analytics server may retrieve data associated with previously performed weldments and their corresponding weld logs (or other welding data). Additionally or alternatively, the analytics may also retrieve discontinuity and anomaly data associated with the weldments. The analytics server may aggregate the retrieved data and generate a training dataset. Using the training dataset, the analytics server may train the first AI model, such that the first AI model can analyze a new dataset and identify possible discontinuities and anomalies.

Additionally or alternatively, the analytics server may include data associated with the material used for the weldment within the training dataset. Furthermore, when the weldment is performed manually, the analytics server may retrieve hand movement data associated with the welder (e.g., how the welding apparatus was handled can be monitored using various sensors).

In some configurations, the analytics server may refine the data retrieved from the welding machine to improve the quality of the training dataset. For instance, a sensor within a welding machine may collect data with a high frequency (every ten milliseconds). The analytics server may average the data received, such that the data used to train the first AI model represents fewer samples (or a lower frequency). For instance, the analytics server may average multiple readings, such that the data indicates average readings for 1 minute time windows.

At step 320, the analytics may train the first AI model. The first AI model may be trained based on previous weldment data. For instance, the analytics server may train the first AI model using previously identified weld discontinuities and their corresponding weld log data. The analytics server may train the first AI model using a supervised method where the discontinuities and their attributes are fully labeled. For instance, the training dataset may be labeled, such that the first AI model can identify the discontinuities and other anomalies within a weldment. The first AI model can also connect the labeled discontinuities with their corresponding weld logs. Using various AI training techniques, the first AI model may identify hidden patterns within the data, such that the first AI model can identify new discontinuities given a new set of weld log data.

Additionally or alternatively, the analytics server may use an unsupervised method where the training dataset is not labeled. Because labeling the data within the training dataset may be time-consuming and may require vast computing power, the analytics server may utilize unsupervised training techniques to train the first AI model.

The analytics server may retrieve attributes associated with previous weldments. Specifically, the analytics server may retrieve weld log data associated with previously performed weldments. In some configurations, the analytics server may retrieve additional data associated with the weldment. Therefore, data used to train the first AI model is not limited to the weld log data.

While training the first AI model, the analytics server may execute a dimension reduction protocol to the attributes to reduce training time and the computing resources needed to train the first AI model. For instance, the analytics server may analyze all attributes received within a weld log and only focus on two or three attributes by mapping the other attribute accordingly (dimensionality). By transforming the training data from a high-dimensional space into a low-dimensional space, the analytics server does not unreasonably sacrifice accuracy because the low-dimensional representation of the weld log still retains meaningful properties of the original data within the weld log (close to its intrinsic dimension).

The analytics server may use various dimension reduction techniques, such as analyzing the weld logs within the training dataset and removing the mutual data. For example, if an attribute of a welding log has values within a portion of the welding logs that are within similar ranges, that particular attribute may not be the most suitable indicator of an anomaly or a discontinuity.

After applying the dimensional reduction protocols, the analytics server may cluster the data. While the number of clusters can be manually identified, the analytics server may optimize the number of clusters by iteratively clustering the data, identifying the distance between the clusters, and re-clustering the data accordingly.

The analytics server may first cluster the data. The analytics server may use various clustering techniques (e.g., K-means clustering, Gaussian mixture model clustering (GMM), density-based spatial clustering (DBSCAN), and/or spectral clustering) to cluster the data. In some configurations, the analytics server may execute all four methods and select the clustering method that produces better results.

The analytics server may then calculate a distance between the clusters. The analytics server may use various existing methods to calculate the distance between the clusters. The analytics server may then adjust the number of clusters and re-cluster the data. The goal of adjusting the number of clusters and re-clustering is to reduce the sum of distances between clusters. For instance, if the clusters have at least one distance that satisfies a threshold, the analytics server may adjust the number of clusters (reduce the number of clusters by one) and iteratively re-cluster the data. Because the number of clusters is reduced, the re-clustering produces bigger clusters (certain clusters will be combined and will include more data points). The analytics server may iteratively repeat the above-described process until the clusters are optimized. As a result, the analytics server identifies an optimum number of clusters that represent differences within the data. Therefore, the number of clusters may differ based on the data ingested by the first AI model.

Referring now to FIG. 3B, a non-limiting examples clustering the data is presented. As discussed above, the analytics server may optimize a number of dimensions and cluster the data in accordance with the optimized number of dimensions and clusters. Charts 330-336 illustrate data (weld log data associated with previous weldments) that have been clustered into three clusters. Each chart corresponds to a different clustering method. For instance, chart 330 illustrates data decomposition when the analytics uses K-means clustering method, chart 332 illustrates data decomposition when the analytics server uses the DBSCAN clustering method, chart 334 illustrates data decomposition when the analytics survey uses a GMM clustering method, and chart 336 illustrates data decomposition when the analytics survey uses spectral clustering method.

The analytics server may analyze the cluster data to identify whether the cluster data is represented by normal or anomalous data. Each cluster may represent a centroid of differences within the data. Therefore, a cluster that represents a small portion of the data (e.g., minority cluster) that is different than the rest of the data (e.g., using various statistical methods) may represent an anomaly. In contrast, a big cluster may indicate that the data is within normal ranges. Therefore, by clustering the data into the optimized number of clusters, the analytics server identifies a data decomposition that separates normal data from anomalous data. As depicted in chart 340, when clustering the data using the DBSCAN clustering method, only 0.3% of data is shown as anomalous, which is more consistent with a realistic analysis of anomalous data percentage for weldments (other clustering methods indicate that 16%-18% of welding data in anomalous). As a result, the analytics server chooses the DBSCAN clustering method.

Upon selecting the anomalous cluster, the analytics server may identify the attributes within the anomalous cluster. Specifically, the analytics server may identify the anomalous data points within the identified cluster and may determine corresponding attributes (within the weld log) to each data point. Essentially, the analytics server may determine what each data point within the anomalous cluster represents within the weld log, as depicted in chart 350. Therefore, the chart 350 indicates which attributes of the weld log can indicate normality and abnormality and their corresponding ranges. More specifically, the chart 350 indicates mean values and standard values of attributes within the anomalous cluster. For instance, lead and/or tail (when applicable) current of 0.162738 amps indicates an abnormality while lead and/or tail (when applicable) current of −0.005040 amps indicates normality.

When analyzing data associated with a new weld log, the first AI model may determine a lead and/or tail (when applicable) amp value and compare the lead and/or tail (when applicable) amp value of the new weld log to the value depicted in chart 350 to determine whether the new weld log indicates an abnormality. For instance, when applying and analyzing new weld log data, if a mean value for the lead and/or tail (when applicable) current of a pass is closer to the value identified as anomalous, it is more likely that there is a welding discontinuity within the identified pass.

While each attribute being within the anomalous range may not guarantee abnormality (or discontinuity) in the weldment, a combination of weldment attributes being within the anomalous range may indicate a high likelihood of a welding discontinuity. Accordingly, a higher number of attributes that are outside the depicted ranges indicates a higher likelihood of discontinuity.

After the training is completed, the trained first AI model may execute the above-described analytical process for weld log data for each pass and may calculate a likelihood of discontinuity within each pass. For instance, the trained first AI model may calculate a score indicative of a likelihood of discontinuity within each pass. Referring now to FIG. 6, a non-limiting example of the score calculated for each pass is depicted. For instance, the indicator 606 indicates that the trained first AI model has analyzed the weld log data within the R6 pass and has calculated a high likelihood of discontinuity within the said pass.

Referring back to FIG. 2, the analytics server may apply the first AI model to generate a score for different passes and/or different zones within each zone/pass. Referring now to FIG. 6, chart 600 visually depicts different scores calculated for each pass and each zone of different weldments. The X-axis in the chart 600 may represent a weldment. The Y-axis may represent different passes/zones. For instance, column 602 represents different scores generated by the analytics server (via executing the first AI model) for weldment number 1. Moreover, the row 604 corresponds to different scores generated by the analytics server (via executing the first AI model) for zone R6 of different weldments. Each indicator depicted in the chart 600 may correspond to a weldment and a particular zone/pass. For instance, the indicator 606 identifies the score calculated for zone R6 of the first weldment. Similarly, the indicator 608 identifies the score calculated for the third weldment at zone R8.

As depicted, each indicator may also include a number that corresponds to the score calculated. For instance, the indicator 606 identifies that the analytics server has calculated a score of 3.5 and the indicator 608 identifies a score of 1.3. This indicates that there is a high likelihood that the second weldment may have a discontinuity at zone R6 and there is a moderate chance of a discontinuity within zone R8 of the third weldment.

The analytics server may use various predetermined scales for the scores calculated. For instance, the analytics server may display a percentage likelihood or may use any predetermined and revisable scale best suited for the end-user (e.g., scale of 1-5 or 1-10). Furthermore, the analytics server may use heat maps and color-coding to visually indicate zones with a high probability of discontinuity. In some embodiments, the analytics server may display the chart 600. Additionally or alternatively, the analytics server may display predetermined text information corresponding to the calculated score. For instance, the analytics server may execute a predetermined look-up table to identify text corresponding to different score ranges and display the text accordingly. For instance, when the calculated score satisfies a threshold (e.g., more than 80% likelihood of a discontinuity being present), the analytics server may display a predetermined text (e.g., “high risk”).

Various attributes of the chart 600 may be customizable and revisable by the end-user viewing the chart 600. For instance, the end-user may revise scales, color coding, placement of each indicator. In some embodiments, the end-user may input a threshold and instruct the analytics server to filter the indicators accordingly. For instance, the end-user may instruct the analytics server to only display scores for zones/weldments having a likelihood of a discontinuity of more than 50% (or any other threshold defined by the end-user). The end-user may also revise and/or filter different weldments and/or zones/passes, such that the chart 600 only includes relevant and requested information.

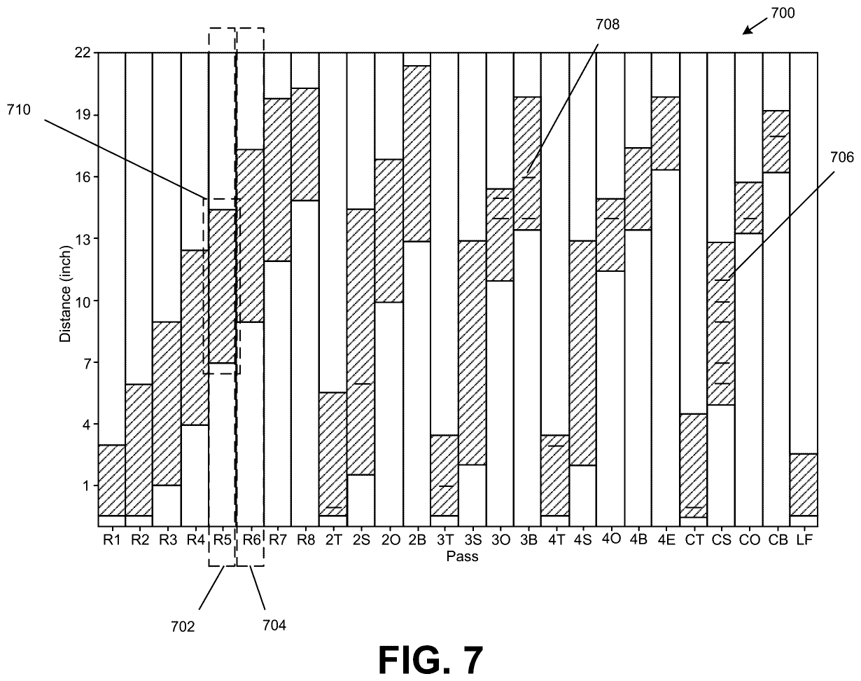

Referring now to FIG. 7, chart 700 depicts another non-limiting example of visualizing data generated by the first AI model, in accordance with an embodiment. The analytics server may generate the chart 700 that visually depicts anomalies and discontinuities within a weldment. The chart 700 shows anomalies and discontinuities for various passes and depths within one weldment. However, it is expressly understood that different embodiments and variations of the chart 700 may include multiple weldments. Furthermore, the analytics server may revise and customize the chart 700 based on inputs received from a system administrator and/or the end-user.

The chart 700 may include graphical indicators identifying locations of the detected discontinuities and anomalies within a weldment. More specifically, the chart 700 may identify a depth associated with a potential discontinuity calculated by the first AI model. The x-axis of the chart 700 may correspond to different passes (e.g., R1-LF). The y-axis may correspond to the depths of different passes. For instance, the column 702 may correspond to different depths of zone/pass R5 of a particular weldment. Similarly, the column 704 may correspond to different depths of zone/pass R6 of the same weldment. Each column may include a portion that is visually distinct. The visually distinct portion identifies the relevant depths of each pass. For instance, the visually distinct portion 710 within the column 702 identifies the range of the corresponding welding zone/pass.

The analytics server may display various graphical indicators identifying a potential discontinuity. Each graphical indicator may correspond to a depth and a zone/pass. Therefore, each graphical indicator visually depicts a location of a possible discontinuity as calculated by the first AI model. For instance, the analytics server displays the graphical indicator 706, which visually identifies that the zone/pass CS may have a discontinuity at the depth of 11 inches. Similarly, the analytics server may display the graphical indicator 708 visually identifying that the weldment may suffer from a discontinuity in the zone/pass 3B at the depth of 16 inches.

The analytics server may revise the graphical indicators based on inputs and preferences of the end-user and/or the system administrator. For instance, the graphical indicators may be shown using different graphical elements, media elements, colors, and the like. The end-user may customize the graphical indicators, as needed. In some configurations, the analytics server may also display a corresponding score representing a likelihood of discontinuity calculated by the first AI model. For instance, in addition to displaying the graphical indicators depicted in chart 700, the analytics server may display a score similar to the scores depicted in chart 600, depicted in FIG. 6. Additionally or alternatively, the scores may be color-coded. Additionally or alternatively, the analytics server may revise the chart 700, such that the scores are only displayed upon the end-user's request, such as by interacting with the graphical indicators (e.g., clicking or hovering over the indicators).

The analytics server may customize the chart 700 such that an indicator is only displayed when a likelihood of a discontinuity satisfies a threshold. For instance, the analytics server may only display an indicator identifying a potential discontinuity when the likelihood of a discontinuity calculated by the first AI model satisfies a predetermined and revisable threshold (e.g. the likelihood is more than 75%).

Referring back to FIG. 2, at step 230, the analytics server may execute a second AI model to generate an image, the server applying the one or more attributes associated with at least one discontinuity generated by the first AI model to the second AI model, wherein the second AI model is trained based on previously identified welding discontinuity attribute and their corresponding visual attributes.

Embodiments described herein describe the second AI model as a separate AI model (different than the first AI model) so describing the functionality of each AI model is easily described. The methods and systems described herein can be implemented such that a single AI model can act as the first and the second AI models. For instance, a single AI model may identify anomalies and discontinuities and generate a visualization for the identified anomalies and discontinuities. In some other configurations, the functionality described herein can be divided among more than two AI models. Therefore, the methods and systems described herein are not limited to implementations where two AI models are utilized.

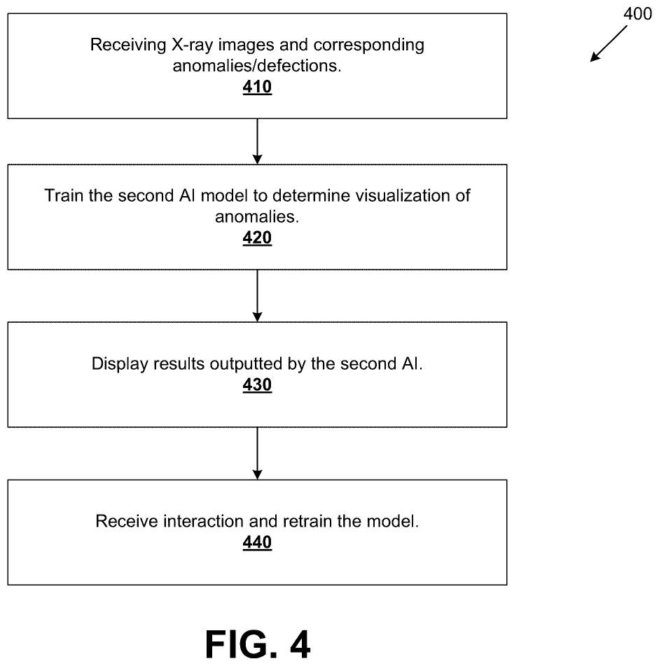

In addition to the data visualization methods described herein, the analytics server may also generate a pseudo weldment image that can be analyzed by the end-user. The analytics server may train and execute the second AI model in according to the systems method 400. FIG. 4 illustrates a flow diagram of a process executed in an anomaly-detection system, according to an embodiment. The method 400 includes steps 410-440. However, other embodiments may include additional or alternative execution steps or may omit one or more steps altogether. The method 400 is described as being executed by a server, similar to the analytics server described in FIG. 1A. However, one or more steps of method 400 may also be executed by any number of computing devices operating in the distributed computing system described in FIG. 1A. For instance, one or more computing devices (e.g., end-user devices) may locally perform part or all the steps described in FIG. 4.

The analytics server may generate, train, calibrate, and execute the second AI model that can utilize the output of the first AI model and generate a visual representation of anomalies and discontinuities described herein. Specifically, the second AI model may generate a visual representation that is similar to visual representations conventionally used by technicians to identify discontinuities and anomalies. As described herein, conventional methods use X-ray imaging systems to generate an X-ray of the weldment. The X-ray image may visually depict areas having anomalies and discontinuities. Also as described herein, other conventional methods may generate an ultrasound image of the weldment.

In a conventional approach, a trained technician may then manually analyze the generated images (e.g., X-ray and/or ultrasound images) and determine whether any anomalies and discontinuities exist. This manual process includes the subjective understanding and skills of the technician. Therefore, the results (e.g., identification of location, type, depth, and/or other attributes of anomalies in discontinuities) are highly dependent on each technician's subjective understanding of the welding process and his/her skills. This conventional process has led to many errors, misidentification, and miss characterization of discontinuities and/or their attributes. Non-limiting example of a type can be a root cause (e.g., gas pocket or slag) and/or a characterization (e.g., industry-standard name), other issued, and the like.

As described herein, the analytics server may execute the first AI model to identify various attributes of anomalies and discontinuities associated with a weldment. The analytics server displays the results using one or more of the visual representations discussed herein, such as by displaying GUIs described in FIGS. 6-10.

The analytics server may visually represent attributes calculated by executing the first AI model. For instance, the analytics server may generate a three-dimensional model representing the weldment or may display the scores generated by the first AI model. In another example, as described in the method 400, the analytics server may re-create conventional imaging (e.g., X-ray and/or ultrasound imaging) of the weldment. These re-created images simulate images generated using X-ray and/or ultrasound machines. Because many technicians have been trained to detect anomalies and discontinuities using these images, technicians may be better-suited to viewing results generated by the analytics server in a familiar format. The analytics server may execute the first and/or second AI models to simulate the weldment and visually represent the weldment in two, three, or four-dimensional images. The analytics server may first calculate a likelihood of one or more discontinuities existing within different layers of the weldment. The analytics server may then generate a visualization of the identified discontinuities, as depicted in FIGS. 6-9.

The analytics server may execute the method 400 and may generate pseudo-X-ray images and pseudo-ultrasound images that resemble actual X-ray and/or ultrasound images generated from the weldment. The pseudo-X-ray and/or pseudo-ultrasound images may then be transmitted to a client device (e.g., one or more GUIs described herein), such that these images can be used by trained technicians to identify discontinuities. The analytics server may display the images generated using the method 400 in conjunction with (or instead of) actual weldment images.

At step 410, the analytics server may retrieve various images associated with welded areas and their corresponding anomalies and discontinuities. At step 420, the analytics server may use the data retrieved to train the second AI model. For instance, the analytics server may query and retrieve bore logs, weld logs, images produced that correspond to weldments (e.g., X-ray and/or ultrasound images produced from welded areas), and/or welding discontinuities and anomalies. The analytics server may use this information to train the second AI model. Training of the second AI model allows the second AI model to uncover corresponding parameters between welding anomalies/discontinuities and the manifestation of the discontinuities within welding images (e.g., X-ray and/or ultrasound images).

The analytics server may train the second AI model using various machine learning techniques. Specifically, the analytics server may use a supervised, unsupervised, and/or semi-supervised learning method to train the second AI model. The amount of available data may dictate the type of machine learning techniques used. Once trained, the analytics server may execute the second AI model using the predicted anomalies and discontinuities to generate a welding image (e.g., pseudo-X-ray and/or pseudo-ultrasound image) to be displayed for the end-user.

In a non-limiting example of the analytics server implementing a supervised learning technique, the analytics server may retrieve a historical list of welding anomalies and discontinuity and their corresponding X-ray images. For instance, the analytics server may query and retrieve (from internal and/or external databases) data associated with previously performed and inspected weldments. The data may include an X-ray and/or ultrasound image of the weldments, welding attributes as described herein, and/or attributes of welding errors, discontinuities, and anomalies. The analytics server may then train the second AI model in accordance with the data retrieved. Specifically, the analytics server may use the data retrieved as the ground truth training dataset.

In the supervised learning method, the analytics server may identify anomalies and discontinuities attributes that correspond to anomalies in discontinuities depicted in their corresponding X-ray and/or ultrasound images. Using various clustering methods and other machine learning techniques, the second AI model may cluster and learn how visual attributes of images produced from weldments correspond to identified discontinuities and anomalies of the same weldments. Because the ground truth dataset comprises historical data known to be accurate, the second AI model may train itself, such that the second AI model identifies how various discontinuities and anomalies are depicted/manifested within X-ray and/or ultrasound images. For instance, the second AI model may identify how welding discontinuity having particular attributes are depicted in X-ray and/or ultrasound images and may train itself accordingly.

In the supervised learning method, the analytics server (or a system administrator operating and implementing the training method) may designate the training data as the ground truth dataset. Using this designation, the second AI model may train itself accordingly (e.g., assume that the training dataset is accurate). The analytics server may train the second AI model such that, given discontinuities and anomaly attributes of a newly performed weldment, the second AI can calculate the relationship between the anomaly attributes and the visual attributes of the welding images. The second AI model may then generate a pseudo-image that represents the inputted discontinuities and anomalies attributes.

In a non-limiting example of the analytics server implementing an unsupervised machine learning technique, the analytics server may repeat similar steps as the supervised techniques. However, the analytics server may not designate the training dataset as the ground truth. For instance, instead of identifying accurate welding anomalies and discontinuities, the analytics server may generate a similar training dataset that comprises previously performed weldments and their corresponding information (e.g., images and welding data), if available.

In the unsupervised learning approach, the analytics server may not label outputs (e.g., images of welded areas depicting anomalies and discontinuities). As a result, the second AI may infer the structure and patterns present within the training dataset. The second AI model may use clustering and density estimation techniques to identify the inherent structure of data without using explicitly provided labels, such as provided in the supervised learning method. In operation, the analytics server may input various images and their corresponding data and the second AI model may train itself using machine learning techniques, such as K-means clustering.

The analytics server may not be limited to the above-described machine learning techniques. For instance, the analytics server may use both techniques, wherein the analytics server may label data when applicable and use a supervised training method (e.g., certain portions of the data are labeled as ground truth). If the analytics server cannot verify the accuracy of portions of the data retrieved, the analytics server may use an unsupervised training method. Therefore, the analytics server may use a semi-supervised method to train the second AI model.

During training, the analytics server may iteratively produce new images and map the visual characteristics of the discontinuities (on the computer-generated images) with real characteristics of discontinuities and/or visual characteristics of a real image (e.g., actual image produced from the actual discontinuity using an X-ray machine). If the characteristics of the computer-generated image do not match the real characteristics of the discontinuity (within a certain tolerance), the analytics server continues the training until and unless the computer-generated image has discontinuity characteristics that are within an acceptable range.

The analytics server may continuously train and improve the second AI model using end-user interactions. In some configurations, the analytics server may train the second AI model using a predetermined portion (e.g., fold) of the ground truth data. The analytics server may then gauge the second AI model's accuracy (e.g., area under the curve, precision, and recall) using the remaining data points within the training dataset (e.g., second fold). For instance, the analytics server may train the second AI model using 75% of the ground truth data. The analytics server may then use the remaining 25% of ground truth data to gauge the accuracy of the train second AI model. The analytics server may continuously and iteratively train the second AI model until and unless the second AI model's accuracy satisfies a predetermined threshold.

In some embodiments, the analytics server may utilize generative adversarial networks (GANs) to improve the image-generation techniques described herein. As described herein, the second AI model may produce a pseudo image of the weldment. In order to improve the image, the analytics server may also utilize an adversarially trained discriminator (e.g., a third AI model).

The third AI model may be trained to distinguish “actual” and “real” weldment images from computer-generated images. By executing the third AI model, the analytics server may determine a likelihood that the image outputted by the second AI model is real or fake (machine-created). The analytics server may continuously/periodically execute the second and third AI models adversarially to improve the images generated by the second AI model.

At step 430, the analytics server may (as a part of training the second AI model) execute the second AI model using data corresponding to previously performed weldments. For instance, the analytics server may execute the trained second AI model using the data retrieved and step 410. As a result, the second AI model may generate and display welding images that visually depict different anomalies and discontinuities. The analytics server may display the images produced as a result of executing the second AI model to different technicians trained to identify welding anomalies in discontinuities using X-ray and/or ultrasound images.

The analytics server may use the images produced in step 430 to further train and revise the second AI model. For instance, at step 440, the analytics server may retrain the second AI model based on responses received from the technician. For instance, the technician may submit an input identifying that a predicted result is incorrect. For instance, the technician may determine that the image of a welding discontinuity produced by the second AI model does not appropriately illustrate the discontinuity or does not match attributes of the discontinuity. The analytics server may use this information to revise and retrain the second AI model. The analytics server may repeat retraining until and unless the second AI model has reached an accuracy level that satisfies a predetermined threshold.

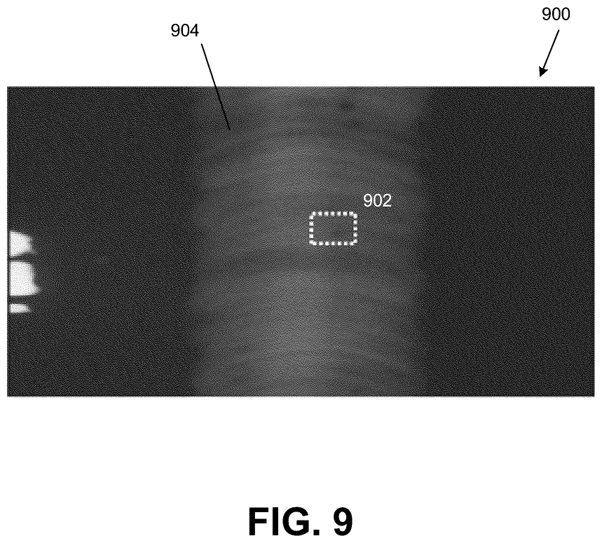

Referring now to FIG. 9, a non-limiting example of an image generated by the second AI model is illustrated, in accordance with an embodiment. As described above, the analytics server may generate an image that resembles an X-ray or ultrasound image produced from the weldment. This computer-generated image may be constructed solely based on attributes generated by the analytics server (e.g., via executing the first AI model).

The image 900 may resemble an X-ray image of a weldment performed on a pipe 904. Based on discontinuity attributes (e.g., size, location, and type), the analytics server may generate the graphical indicator 902 that resembles a discontinuity within the pipe 904. The graphical indicator 902 represents how a discontinuity having attributes similar to the discontinuity attributes calculated using the first AI model may manifest itself on an X-ray image of the pipe 904. As used herein, size may refer to length, width, and/or volume of the discontinuity corresponding to its shape (e.g., head angle of the discontinuity).

Referring back to FIG. 2, at step 240, the analytics server may present the image generated by the second AI model for display on the client device. Even though aspects of the method 200 are described in the context of displaying an image, the methods and systems described herein are not limited to this embodiment. For instance, the analytics server may display the results (step 220) in a text format (e.g., spreadsheet or charts). Non-limiting examples of alternative forms of displaying the results may include GUIs depicted in FIGS. 6-8. The analytics server may display these alternative forms in addition to or in lieu of the image generated in step 230. Different configurations may be dictated and revised by the end-user based on each end-user preference.

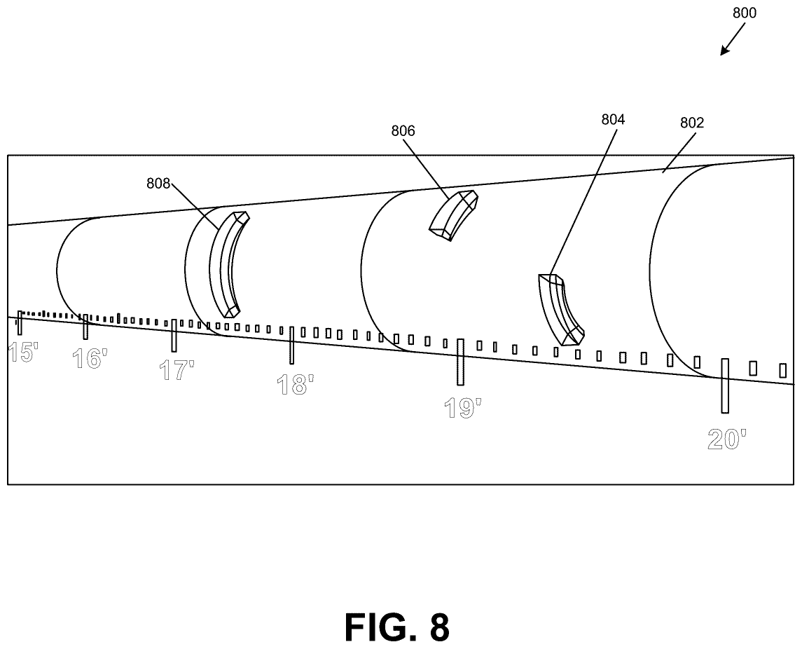

FIG. 8 depicts another non-limiting example of a visualization corresponding to the data outputted by the first AI model, in accordance with an embodiment. The analytics server may generate a three-dimensional representation of the weldment and may include various graphical indicators representing possible discontinuities identified by the first AI model. For instance, the representation 800 may include the pipe 802 that represents a pipeline having at least two pieces welded by a welding machine. The pipe 802 is a three-dimensional representation of the pipe analyzed by the analytics server. Visual attributes of the pipe 802 (e.g., color, dimensionality, and other visual attributes) may be customized by the end-user and may correspond to the actual pipe depicted.

The representation 800 may also include various graphical indicators identifying possible discontinuities calculated by the analytics server. For instance, graphical indicators 804-806 may each represent a discontinuity and anomaly in the weldment. The visual attributes of each indicator, such as size, color, placement, and other visual attributes may correspond to discontinuity attributes calculated by the analytics server via executing the first AI model. For instance, the graphical indicator 806 has dimensionality that is different from the graphical indicator 804 because the possible discontinuity that corresponds to the graphical indicator 806 is different from the discontinuity corresponding to the graphical indicator 804.

The analytics server may also display various graphical indicators as visually distinct where the distinction corresponds to an attribute calculated by the analytics server. For instance, the analytics server may display the graphical indicator 806 using a different color than the graphical indicator 804. Even though FIG. 8 depicts an embodiment where the analytics server uses different colors, it is expressly understood that the analytics server may use any visual attribute to distinguish the graphical indicators. Non-limiting examples may also include different hatch patterns. In a non-limiting example, the color (or any other method of visually distinguishing an indicator) may correspond to the likelihood of the existence of a discontinuity calculated by the analytics server via executing the first AI model. For instance, the color of each graphical indicator may correspond to the score calculated by the analytics server, as described in FIG. 6.

The graphical indicators depicted in the representation 800 may correspond to data depicted in FIGS. 6-7. For instance, the indicator depicted in the graphical component 808 may correspond to the scores calculated by the analytics server and depicted in column 602 in FIG. 6.

As described above, the analytics server may continuously and iteratively train the first and/or second AI models based on end-user interactions and feedback. The analytics server may monitor various end-users' interactions with the identified data to improve the results by revising and retraining the AI models. The analytics server may monitor the electronic device viewing weldment discontinuities (e.g., as described with respect to FIGS. 6-9) to identify interactions between the end-user and the electronic device while the electronic device is outputting the results. Based on the end-users interactions (e.g., approval, denial, and/or modification of the results), the analytics server may then revise and retrain the AI models.

The analytics server may track and record details of the user's activity when the end-users interact with any of the GUIs described herein. For instance, when a predicted result is displayed on the user electronic device, the analytics server may monitor to identify whether the end-user has interacted with the predicted results by editing, deleting, accepting, or revising the results. The analytics server may also identify a timestamp of each interaction, such that the analytics server records the frequency of modification, duration of revision/correction.

The analytics server may utilize an application programming interface (API) to monitor the end-user's activities. The analytics server may use an executable file to monitor the user's electronic device. The analytics server may also monitor the GUIs displayed via a browser extension executing on the electronic device. The analytics server may monitor multiple electronic devices and various applications executing on the electronic devices. The analytics server may communicate with various electronic devices and monitor the communications between the electronic devices and the various servers executing applications on the electronic devices.

In some embodiments, the analytics server may monitor the data packages received and sent by each electronic device to monitor the content of what is displayed, executed, or modified on the electronic device. The communication may take any suitable form. For example, the electronic device may execute an application (e.g., browser extension) having an executable file that enables an end-user to navigate to the GUIs described herein (e.g., website).

The analytics server may use several techniques to track end-users' activities on the electronic device, such as by tracking browser cookies and/or screen-scraping protocols. In another example, the analytics server may track the end-user activity by periodically retrieving the end-user's web browser cookies. The analytics server may transmit cookies to a system database where they can be analyzed (e.g., in batches) to identify end-user activities and interactions.

In some configurations, the analytics server may monitor the electronic device using an executable file (application) installed as a browser extension. The browser extension (executable file) may be executed as a background process of the electronic device. For instance, the browser extension may be transparent to the end-user operating the electronic device. In this way, the analytics server can monitor the user's activities without disturbing the end user's workflow and/or obfuscating the display screen of the electronic device. In some embodiments, the analytics server may activate a monitoring module (e.g., browser extension or executable file) upon outputting the results (e.g., displaying one or more GUIs).

The analytics server may use the data collected/monitored to train the AI models and improve their predicted results. In order to train the AI models, the analytics server may generate new training datasets.

The analytics server may monitor whether an end-user accepted the predicted results. The analytics server may generate a metric corresponding to a frequency that a certain predicted result was accepted, denied, or revised. If the predicted results were accepted, the analytics server assumes that the predicted results were satisfactory to the end-user. If the end-user revised the predicted results, the analytics server assumes that they were partially satisfactory to the user. Finally, if the end-user denied the predicted results, the analytics server assumes that they were unsatisfactory. The analytics server may also generate a metric for how frequently predicted results generated by a model is accepted, revised, and/or denied.

As described above, when an end-user revises a predicted result, the analytics server monitors the revision performed by the user. In some embodiments, the analytics server displays a predicted result on user devices. However, the end-users may feel the need to perform minor corrections before they are satisfied with the results. The analytics server may monitor these corrections and generate training datasets accordingly. For instance, the analytics server may monitor a time duration that each end-user spent correcting the predicted results. The analytics server may assume that a higher monitored time duration corresponds to more inaccurate results.

In some embodiments, the analytics server may also monitor the corrections themselves and use this data to train the AI models. For instance, training and revising the machine-learning model may be proportionally implemented based on the end-users modifications. For instance, the analytics server may generate a training dataset that includes the amounts of corrections inputted by the end-user (e.g., whether the end-user revised the results by 10% or 80%).

The analytics server may always display a prompt requesting end-users feedback. In some embodiments, the analytics server may display the prompt based on a predetermined frequency (e.g., 50% of instances where a predicted result is displayed). Furthermore, the analytics server may select the end-users receiving the prompt based on predetermined rules. For instance, the analytics server may select the end-users randomly. In some configurations, the predetermined rules may require the analytics server to display the prompt for end-users who satisfy a certain threshold (e.g., only for end-users who have three or more years of experience).

The analytics server may train the first and/or second AI models using the above-described training datasets. The analytics server may use various methods to train the machine-learning model, such as supervised and/or unsupervised learning methods. For instance, the analytics server may use one or more of the following machine-learning approaches to train the AI models: regression, classification, clustering, dimensionality reduction, ensemble methods, neural nets, and deep learning, transfer learning, reinforcement learning, and the like. In some embodiments, the analytics server may periodically train the machine-learning model. For instance, the analytics server may collect/monitor end-user interactions and store the corresponding data. The analytics server may then use a predetermined frequency (e.g., once a month or once a week) to train the machine-learning model using the stored training datasets. A system administrator can modify the frequency of the batch training.

Additionally or alternatively, the analytics server may train the AI models when the model produces results that receive feedback that satisfies a threshold. For instance, the analytics server trains the model when the results outputted by the analytics server receive feedback (e.g., rejection or modification/revision of the results by the end-users) more frequently than a predefined threshold (e.g., 40% of the time).

Additionally or alternatively, the analytics server may train the model based on a customized (predetermined) segmentation of training data and/or end-users. For instance, the analytics server may segment the training data before training the AI model. The analytics server may train the AI model in a customized and segmented manner that is meaningfully tethered to the end-users' needs. In a non-limiting example, the analytics server may train the AI models based on feedback received from a selection of end-users. As a result, the analytics server may customize the AI models for a particular job site. This training method allows the machine-learning model to adapt to the particular job site and produce results that are more acceptable to the end-users within that job site.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods is not limiting the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate the transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What we claim is:

1. A method comprising:
receiving, by a processor, a plurality of attributes corresponding to a weldment;
executing, by the processor, a first artificial intelligence model to identify one or more attributes associated with at least one discontinuity of the weldment,
wherein the first artificial intelligence model was trained based on one or more attributes corresponding to previous weldments having at least one discontinuity, and
wherein the one or more attributes associated with the at least one discontinuity of the weldment correspond to at least one of a type or a location of the discontinuity; and
presenting, by the processor, the one or more attributes associated with at least one discontinuity for display.

2. The method of claim 1, wherein the processor receives the plurality of attributes from a welding machine.

3. The method of claim 1, further comprising:
executing, by the processor, a second artificial intelligence model that receives an input of the one or more attributes associated with the at least one discontinuity generated by the first artificial intelligence model and generates an image that simulates the at least one discontinuity,
wherein the second artificial intelligence model was trained based on one or more attributes associated with the at least one discontinuity corresponding to previous weldments and one or more visual attributes associated with the at least one discontinuity of the previous weldments; and
presenting, by the processor, the image generated by the second artificial intelligence model for display.

4. The method of claim 3, wherein the image simulates an X-ray image of the weldment or a pseudo-ultrasound image of the weldment.

5. The method of claim 1, wherein the plurality of attributes comprise at least one of event description, time associated with welding of the weldment, changes per tilt, tilt attributes, travel speed, distance, volts, direction, amps, wire speed, oscillation width, target, horizontal right bias, oscillation rates, wire consumed, or energy.

6. The method of claim 1, wherein at least one attribute within the one or more attributes associated with the at least one discontinuity corresponds to a discontinuity size.

7. The method of claim 1, wherein first artificial intelligence model calculates a likelihood of discontinuity being present within the weldment.

8. The method of claim 7, wherein the first artificial intelligence model further calculates a depth associated with each discontinuity.

9. The method of claim 1, further comprising:
responsive to an identification by the first artificial intelligence model, transmitting, by the processor, an instruction to a welding machine to modify a welding process.

10. The method of claim 9, wherein the instruction comprises at least one of re-calibration of the welding machine, auto-correction of the welding machine, or indication of a problematic area of the weldment.

11. A system comprising:
a processor associated with a non-transitory computer-readable medium containing instructions that when executed by the processor causes the processor to perform operations comprising:
receive a plurality of attributes corresponding to a weldment;
execute a first artificial intelligence model to identify one or more attributes associated with at least one discontinuity of the weldment,
wherein the first artificial intelligence model was trained based on one or more attributes corresponding to previous weldments having at least one discontinuity, and
wherein the one or more attributes associated with the at least one discontinuity of the weldment correspond to at least one of a type or a location of the discontinuity; and
present the one or more attributes associated with at least one discontinuity for display.

12. The system of claim 11, wherein the processor receives the plurality of attributes from a welding machine.

13. The system of claim 11, wherein the instructions further cause the processor to:
execute a second artificial intelligence model that receives an input of the one or more attributes associated with the at least one discontinuity generated by the first artificial intelligence model and generates an image that simulates the at least one discontinuity,
wherein the second artificial intelligence model was trained based on one or more attributes associated with the at least one discontinuity corresponding to previous weldments and one or more visual attributes associated with the at least one discontinuity of the previous weldments; and
present the image generated by the second artificial intelligence model for display.

14. The system of claim 13, wherein the image simulates an X-ray image of the weldment or a pseudo-ultrasound image of the weldment.

15. The system of claim 11, wherein the plurality of attributes comprise at least one of event description, time associated with welding of the weldment, changes per tilt, tilt attributes, travel speed, distance, volts, direction, amps, wire speed, oscillation width, target, horizontal right bias, oscillation rates, wire consumed, or energy.

16. The system of claim 11, wherein at least one attribute within the one or more attributes associated with the at least one discontinuity corresponds to a discontinuity size.

17. The system of claim 11, wherein first artificial intelligence model calculates a likelihood of discontinuity being present within the weldment.

18. The system of claim 17, wherein the first artificial intelligence model further calculates a depth associated with each discontinuity.

19. The system of claim 11, wherein the instructions further cause the processor to transmit an instruction to a welding machine to modify a welding process responsive to an identification by the first artificial intelligence model.

20. The system of claim 19, wherein the instruction comprises at least one of re-calibration of the welding machine, auto-correction of the welding machine, or indication a problematic area of the weldment.
